(19) United States
(12) Patent Application Publication
(10) Pub. No.: US 2008/0302870 A1
(43) Pub. Date: Dec. 11, 2008

(54) COMPUTERIZED BIOMETRIC PASSENGER IDENTIFICATION SYSTEM AND METHOD

(75) Inventors: Dario Berini, Ashburn, VA (US); Bryon Fevens, Nepean (CA); Ilan Arnon, Ottawa (CA); Robert Bell, Ottawa (CA)

Correspondence Address: GREENBERG TRAURIG, LLP, 2101 L Street, N.W., Suite 1000, Washington, DC, 20037, US

(73) Assignee: CryptoMetrics, Inc.

(21) Appl. No.: 11/929,429

(22) Filed: Oct. 30, 2007

Related U.S. Application Data
(60) Provisional application No. 60/863,489, filed on Oct. 30, 2006.

(51) Int. Cl. G06K 5/00

(52) U.S. Cl. 235/380

(57) ABSTRACT

A system and method for passenger identity verification. The system has at least one check in system with a barcode reader and a biometric data collection device. When a passenger checks in, a barcode is placed on the passenger's boarding documents, the barcode is read, and biometric data is collected from the passenger. The system stores the data in a database of a server such that the barcode data is associated with the biometric data. The system further contains at least one checkpoint verification system with a bar code reader and a biometric data collection device. When the passenger arrives at the verification system, the barcode is read and biometric data is collected from the passenger. Biometric data is retrieved from the database using the bar code read by the verification system and the biometric data retrieved from the server is compared with the data collected by the verification system.

This Application claims the benefit of U.S. Provisional Patent Application No. 60/863,489 for “Computerized Facial Biometric Passenger Identification System and Method” filed Oct. 30, 2007, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for passenger identity verification and tracking and more particularly to systems and methods for passenger identity verification and tracking using biometric technology.

### BACKGROUND OF THE INVENTION

Transportation services such as airlines, rail lines, and bus lines typically use various security systems to identify, validate, and track passengers to safeguard the transportation service and its passengers, as well as to prevent various kinds of illegal activities, such as illegal entry of foreign nationals into a country without a proper VISA. Such security systems may be significantly enhanced by use of biometric passenger identification technology.

### SUMMARY OF THE INVENTION

Various embodiments of the present invention relate to systems and methods for passenger identity verification and tracking using biometric technology. The embodiments are illustrative, not restrictive, and are intended to provide further explanation of the invention as claimed.

In one embodiment, the invention is a system for passenger identity verification comprising at least one check in system with a barcode reader and a biometric data collection device. When a passenger checks in, a barcode is placed on the passenger's boarding documents, the barcode is read and biometric data is collected from the passenger. The system further contains a server with a database for storing passenger data connected to check in system. the server having a database for storing passenger data. The server stores the barcode data and biometric data on the database such that the barcode data is associated with the passenger's biometric data. The system further contains at least one checkpoint verification system with a bar code reader and a biometric data collection device connected to the server. When the passenger arrives at the verification system, the barcode is read and biometric data is collected from the passenger. Biometric data is then retrieved from the database using the bar code data read by the verification system and the biometric data retrieved from the server is compared with the biometric data collected by the verifier system.

In another embodiment, the invention is a method for passenger identity verification. A barcode is placed on a passenger's boarding documents upon check in. The barcode is read by a barcode reader. Biometric data is collected from the passenger using a biometric collection device. The barcode and biometric data is then stored on a server such that the biometric data is associated with the barcode data. At a verification point, the barcode is again read by a barcode reader and biometric data is collected from the passenger using a biometric collection device. Biometric data is retrieved from the server using the barcode read at the verification point and the biometric data retrieved from the server is compared with the biometric data collected at the verification point.

### BRIEF DESCRIPTION OF THE DRAWINGS

The accompanying drawings illustrate embodiments of the invention and together with the description serve to explain the principles of at least one embodiment of the invention.

Reference characters and numbers refer to the same parts throughout the various views whenever possible. The drawings are not necessarily to scale, emphasis instead being placed upon illustrating principles of various embodiments of the invention.

Where illustrations refer to specific manufacturer and model numbers for hardware elements of various embodiments of the invention, the references are intended to be illustrative, not restrictive. It will be obvious to those skilled in the art that a variety of equipment supporting similar functions may be substituted for the components actually shown in the illustrations.

FIG. 1 illustrates one embodiment of a hardware and network configuration that may be used to implement the system.

FIG. 2 illustrates another embodiment of a hardware and network configuration that may be used to implement the system.

FIG. 3 illustrates one embodiment of a hardware and network configuration that may be used to implement a Central Server.

FIG. 4 illustrates one embodiment of a hardware and network configuration that may be used to implement an Airport Server.

FIG. 5 is a conceptual illustration of one embodiment of a Check In Recorder system.

FIG. 6 is a flowchart illustrating one embodiment of the workflow associated with check in of a single passenger by a check in agent.

FIG. 7 is a conceptual illustration of one embodiment a Verifier system.

FIG. 8 is a flowchart illustrating of one embodiment of the workflow associated with the verification of a single passenger boarding an airplane by a airline agent.

FIG. 9 illustrates one embodiment of a report of passengers that have checked-in but not reported to the gate.

FIG. 10 illustrates one embodiment of a report of scheduled passengers who have not checked in.

FIG. 11 illustrates one embodiment of a report to confirm that the correct passengers have deplaned and that there are no passengers remaining on the plane that should have deplaned.

FIG. 12 is a conceptual illustration of one embodiment of a Combo Recorder/Verifier system

### DETAILED DESCRIPTION OF THE PREFERRED EMBODIMENT

Embodiments of the present invention are described below with reference to network diagrams, block diagrams, and operational illustrations of systems and methods for passenger identity verification and tracking using biometric technology. It is understood that each block of the block diagrams or operational illustrations, and combinations of blocks in the block diagrams or operational illustrations, may be implemented by means of analog or digital hardware and computer program instructions.

These computer program instructions may be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

In some alternate implementations, a token may be generated and provided to the traveler that contains some, or all of the data that has been captured at check in, and may be used in tandem or as an alternative to the barcode and/or server stored data.

The embodiments discussed below relate to systems and methods for passenger identity verification and tracking implemented in an airport setting. It will be readily apparent, however, to those skilled in the art, that the systems and methods discussed herein may also be used for passenger identity verification and tracking for any other form of public transportation, such as, without limitation, rail lines, bus lines, and cruise lines. Therefore, nothing in this disclosure should be interpreted as limiting the invention solely to airports or airline security applications.

The term “server” should be understood to refer to a service point which provides processing, database, and communication facilities. As such, therefore, the term “server” may refer to a single, physical processor with associated communications and data storage and database facilities, or it may refer to a networked or clustered complex of processors and associated network and storage devices, as well as operating software and one or more database systems and applications software which support the services provided by the server.

Where various embodiments are illustrated herein or described below, communication links between various hardware elements of the embodiments may be shown as hard wired or as wireless. Such examples are illustrative and not restrictive. It is understood that hardware elements of the various embodiments of the system may communicate with each other using any form of communication link, for example, wireless communication of any type, or hard wiring or cabling of any type. The specific communications technology used will be determined by project needs, as discussed in part, below. All communication links may, furthermore, be encrypted using any of the various techniques well known in the field, or may remain unencrypted.

The system and methods described herein provides improved security in a transportation setting using biometric identification techniques. For example, the system may aid transportation authorities to ensure that passengers are not on the United States Transportation Security Administration No Fly List or Selectee List, hold authentic travel documents, are the rightful holder of such travel documents, and have a valid visa for in-transit stops and the ultimate destination

For example, the capture of face or fingerprint biometrics may enable an Airline or Airport Authority to confirm that there is no accidental or intentional swapping of boarding passes after issuance either before boarding or while on the airplane. Documents may be scanned and added to Passenger Records in order to ensure that passengers can be clearly identified if for some reason they arrive at a foreign border and have “lost” their documents. The captured passenger information may retained centrally together with the record of any security alert overrides so that it may be reviewed by Security when required. An audit trail of security checks, dispositions and overrides may be maintained for analysis by the Airline or Airport Authority Security personnel.

In one embodiment, the system may be implemented using five types of components: Check In Recorders for passenger check in, Verifiers to confirm identity of passenger when boarding or deplaning, combination Recorder/Verifiers to conduct both security check-in and verification functions at international gates; Airport Servers located at Airports which compile, consolidate and log transactions and communicate with Central Servers, and Central Servers for data consolidation and processing.

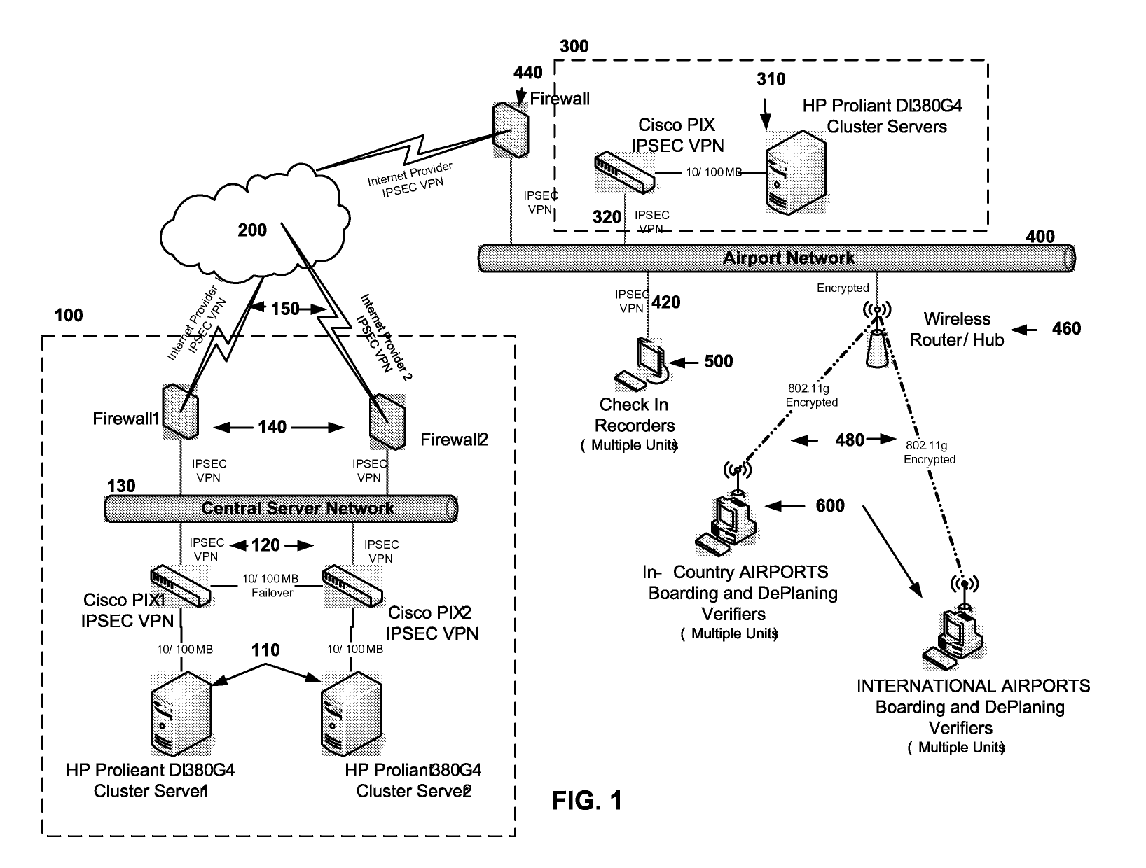

FIG. 1 illustrates one embodiment of a hardware and network configuration that may be used to implement the system. The embodiment contains a Central Server 100, an Airport Server 300 connected to the Central server 100 by an external network 200, for example the Internet, and a plurality of Check In Recorder systems 500 and Verifier systems 600 connected to the Airport Server 300 through an airport network 400. Check In Recorder systems 500 and Verifier systems 600 may be connected to the airport network 400 though VPN 420 or wireless 480 connections.

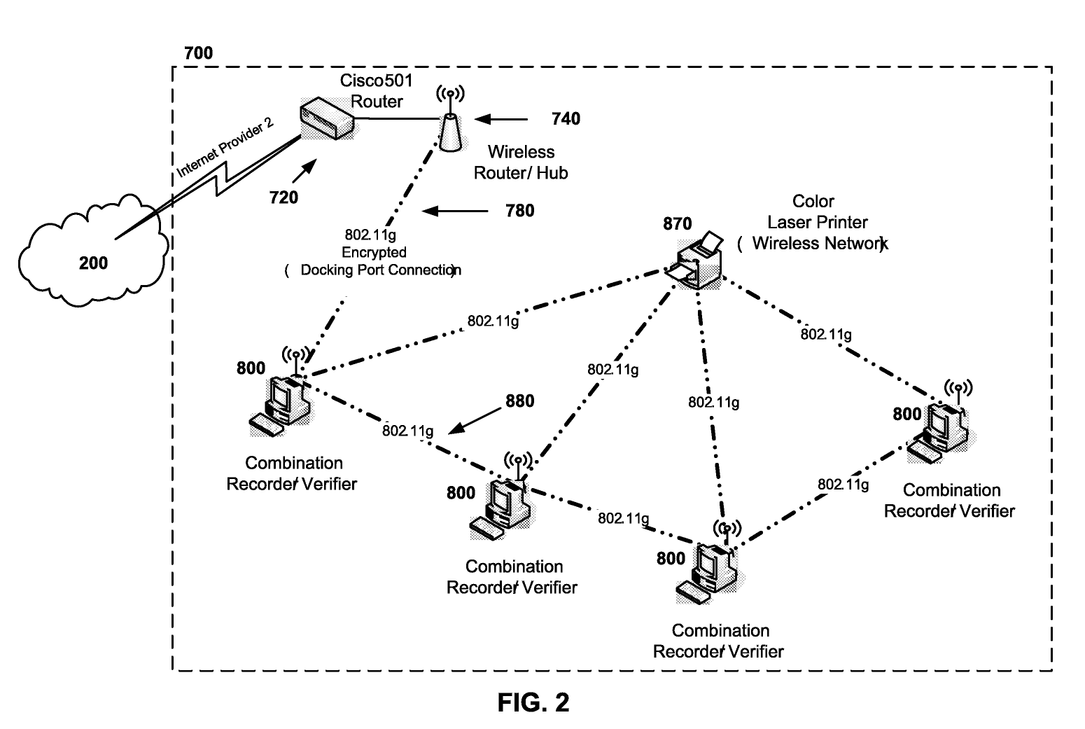

FIG. 2 illustrates another embodiment of a hardware and network configuration that may be used, for example, in an international airport setting. The embodiment uses Combination Recorder/Verifiers 800 at international gates. Combination Recorder/Verifiers 800 are in communication with an Airport Server (not shown) through a wireless network 700 comprising a router 720 connected to an external network 200, such as the Internet, which is connected to a wireless router/hub 740. The wireless router/hub 740 communicates wirelessly 780 with Combination Recorder/Verifiers 800. Combination Recorder/Verifiers 800 may further communicate wirelessly 880 with one another and with a central printer 880.

One of the benefits of embodiments of the system relying principally on wireless technologies is that such embodiments minimizes construction and/or hard wiring within an airport which proves to be the Achilles heal of many system installations that require physical changes within an airport. Scrutiny imposed by governing bodies, adherence to very restrictive mandates and backlog typically cause programs to incur massive delays. Such an embodiment simplifies such issues.

Referring back to FIG. 1, the Central Server 100 serves as a central data storage, coordination, and control point and provides links to airport networks 400 and Airport Servers 300 in connected airports. The Central Server 100 may be located in a central or remote airline or airport authority facility. The Central Server 100 may additionally provide external links to retrieve security data from a variety of sources, including without limitation, the No Fly List (NFL) as updated by TSA daily, the Selectee List (SL Watchlist) as updated by TSA daily, and Airline PAX information that defines each of the passengers that has made a reservation for flights. The information may be correlated to a specific schedule for each flight in time to conduct the NFL and SL checks and advise of any potential hits.

The Central Server 100 may additionally provide outputs, including output of NFL and SL check results to the airline and an historical security data base for all passengers that can be queried by authorized airline or airport authority security personnel. Data may be maintained and retained for multiple years as required by regulations or associated policy requirements.

FIG. 1, 100, shows one embodiment of a central server 100. The server has two cluster servers 110 connected to a server network 130 through VPN connections 120. The cluster servers 110 are redundant, and provide the same services, such that if one cluster server fails, the other cluster server can provide the same services. The server network 130 is connected to an external network, for example, the Internet, through firewalls 140 and redundant connections 150 using, optionally, two different Internet connection providers for enhanced redundancy.

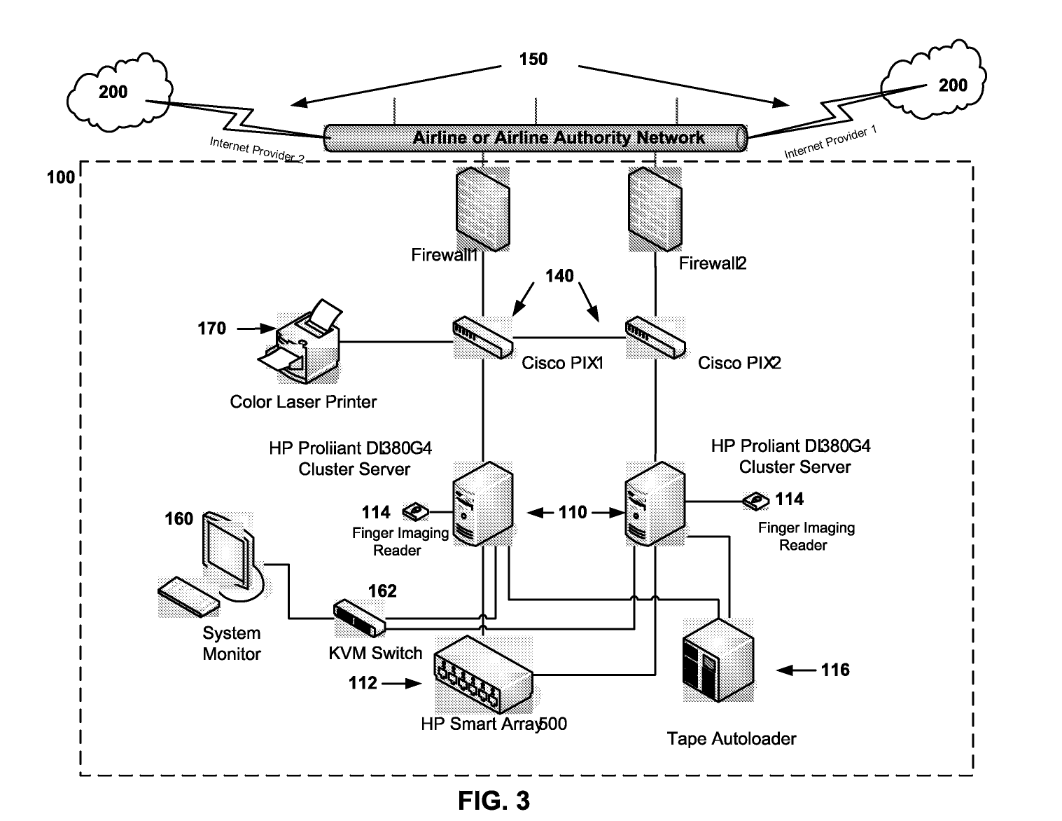

FIG. 3 shows another embodiment of a Central Server 100. The server is configured as a set of mirrored cluster servers 110 with redundant and mirrored storage drives hosting the Operating System. The servers 110 may have two cross connected controllers connected to twin channels on a Storage Array Network (SAN) 112 which contains a bank of hot swappable storage drives. If any of these drives fail, the others may function as a seamless redundant backup without operational downtime. A failed drive may be removed and replaced while the system is running. External connections to the Airport Servers may be handled by redundant communications devices that 140 may provide firewall, VPN and encryption services. The design may incorporate the use of multiple network communication connections provided by different carries or physical wiring with an automatic failover switch should one of the connections drop. The Central Server 100 may additionally provide one or more printers 170 for printing reports generated by the system.

The controllers 110 in the system may be monitored and controlled using a single system monitor 160 connected to the network using a KVM switch 162. In one embodiment, there may be multiple levels of access security so that an airline or airport authority can limit the access of its personnel to system functions on a need to know basis. The system may additionally include fingerprint readers 114 for verifying operator identity. Log-in may be by password and fingerprint to ensure that there is no sharing of passwords and that the transaction records are clearly attributable to one user of the system. All access to the system, as well as any changes, may be logged providing an audit trail available for review.

All data stored by the Central Server 100 may be backed up daily through the use of traditional third party backup software. For example, tape backups may be taken through use of an autoloader 116 with multi-tape capacity so that tapes can be changed on a daily or weekly basis for off-site disaster recovery. Data may be maintained in encrypted form in the central server system, on all components of the system, on communications between computers and on the back-up electronic media, or any combination thereof. The power to the central server system may be backed up with a UPS (Uninterrupted Power Supply) system and dual power supplies in each server. Physical security may be enhanced by utilization of an enclosed rack system cabinet with lockable service doors.

The Central Server 100 may additionally provide tools allowing airline or airport authority personnel to manage aspects of the system. In one embodiment, a supervisor may open a flight when the staff and equipment are ready to start checking in passengers, setting up all of the data required for the flight including PAX, NFL and SL data. A supervisor may close a flight when the passengers are on board. On closing, the passenger data may be prepared for the flight and readied to transmit to the local airport server, the central server and hence on to the destination airport server. A printed manifest for the flight plus a back-up electronic media such as a CD or memory stick may be prepared and provided to the flight crew before departure.

Referring back to FIG. 1, in one embodiment, the Airport Server 300 serves as a data storage, coordination, and control point in an individual airport. In the embodiment shown in FIG. 1, the Airport Server 300 is in communication with a plurality of Check In Recorder systems 500 and Verifier systems 600 through an airport network 400. The Check In Recorders 500 and the and Verifier systems 600 may be connected to the airport network using a VPN connection or a wireless connection. In the embodiment shown in FIG. 1, Check In Recorders 500 are connected to the airport network through a VPN connection 420 and Verifier systems 600 are connected to the airport network through a wireless connection 480. The Airport Server 300 may additionally be in communication with the Central Server 100 through an external network 200 which may be connected to the airport network 400 through a firewall 440.

The Airport Server may store data including passenger check in data received from Check In Recorder systems 500 and external security data, such as No Fly Lists received from the Central Server 100. The Airport Server 300 provides data to Check In Recorder Systems 500 including, without limitation, security data from external sources. The Airport Server 300 may also provide data to Verifier Systems 600, such as passenger check in data received from Check In Recorder Systems 500. The Airport Server 300 may further forward data to the Central Server 100, such as such as passenger check in data received from Check In Recorder Systems 500.

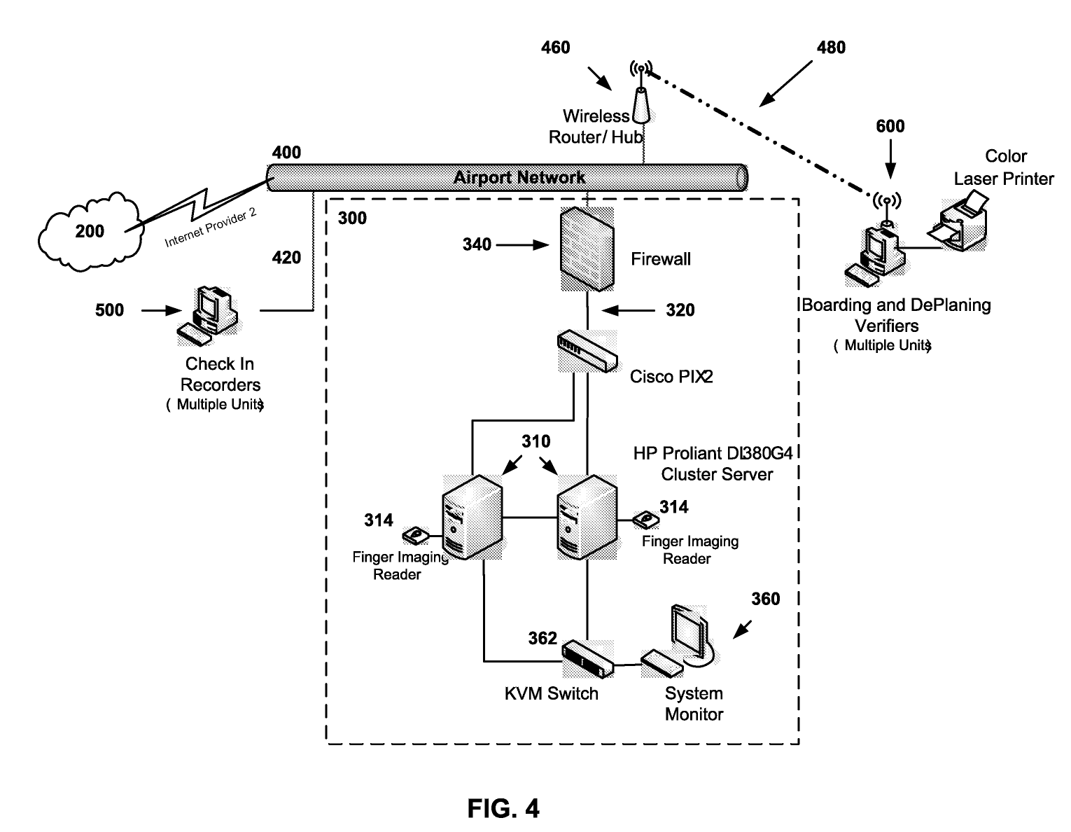

FIG. 4 shows another embodiment of an Airport Server 300. The Airport Server 300 may be engineered with a high availability, highly redundant and robust sub-system architecture. In the embodiment shown in FIG. 4, the Airport Server 300 comprises two cluster servers 310 in tandem which are running a clustered Operating system. In case of failure of any one server the other will take over the operation of the Airport Server 300 and seamlessly continue server functions without disruption. Each of the two servers 310 may be powered by dual power supplies to ensure that each server 310 will continue to function if a power supply or power circuit fails. Disk storage may be mirrored between the servers 310 with two storage disks each having the operating system on both drives for redundancy and failover. Data may also be mirrored and written to both disks drives and in case of failure of any one disk it will continue to function from the other functioning unit.

The cluster servers 310 may be connected to the airport network 400 through a VPN connection 320 and firewall 340. The airport network allows the Airport Server 300 to communicate with the Central Server (not shown) through an external network 200 connected to the Airport Network 400 through a firewall (not shown). In the embodiment shown in FIG. 4, Check In Recorders 500 are connected to the airport network through a VPN connection 420, and Verifier systems 600 are connected to the airport network through a wireless connection 480.

The controllers 310 in the Airport Server 300 may be monitored and controlled using a single system monitor 360 connected to the network using a KVM switch 362. In one embodiment, there may be multiple levels of access security so that an airline or airport authority can limit the access of its personnel to system functions on a need to know basis. The system may additionally include fingerprint readers 314 for verifying operator identity. Log-in may be by password and fingerprint to ensure that there is no sharing of passwords and that the transaction records are clearly attributable to one user of the system. All access to the system as well as any changes may be logged providing an audit trail available for review.

In the embodiments shown in FIG. 1-4, under normal operational conditions, Check In Recorder Systems 500 and the Verifier Systems 600 are in communication with the Airport Server 300 for their respective data, operational and maintenance needs. There is nothing, however, in this disclosure to preclude the Central Server from assuming some, or all, of the functions of the Airport Server 300 in the event the Airport Server is not operational. Note also that in alternative embodiments, the functions of the Central Server 100 and the Airport Server 300 may be embodied in a single consolidated server.

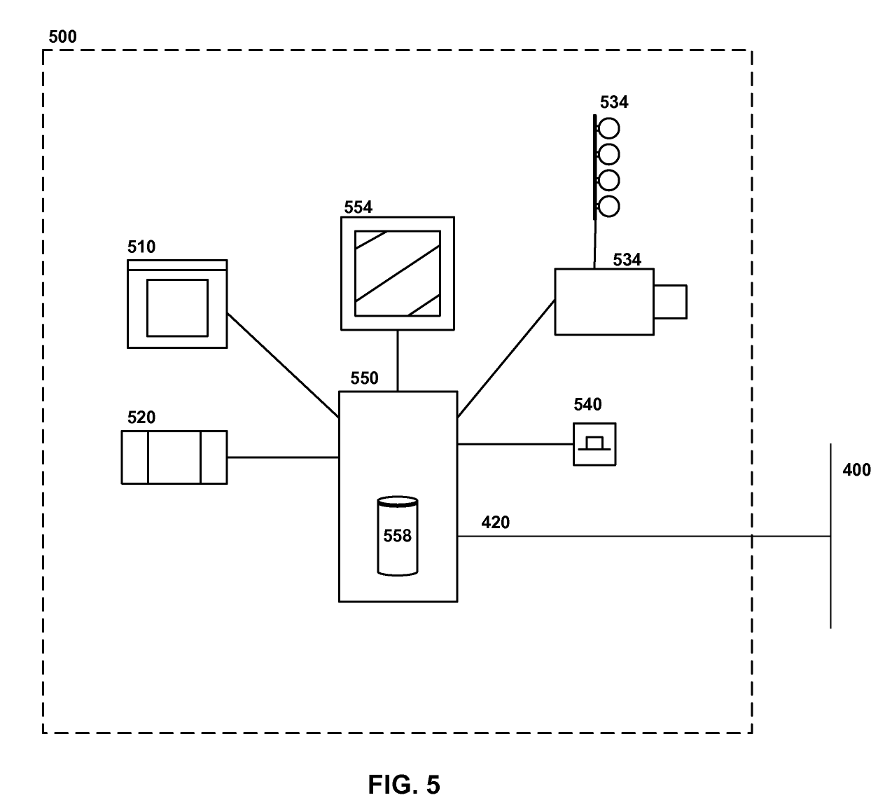

FIG. 5 is a conceptual illustration of one embodiment of a Check In Recorder system 500. The Check In Recorder is a device that is used to collect and verify passenger data at check in. Such data includes boarding pass and ticketing data, passport, visa, and other traveler/worker data, and passenger biometric data. The embodiment in FIG. 5 includes: a full page ID3 travel document reader and authenticator 510; a bar code reader 520; a biometric camera 530 with lighting 534; and a fingerprint capture device 540. All components may be connected to a computer 550 with touch sensitive monitor 554 for an operator interface and a local storage device 558, for example a hard drive. The computer may be connected to the airport network 400 using a hardwired or wireless connection. The embodiment illustrated in FIG. 5 uses a hardwired VPN connection 420.

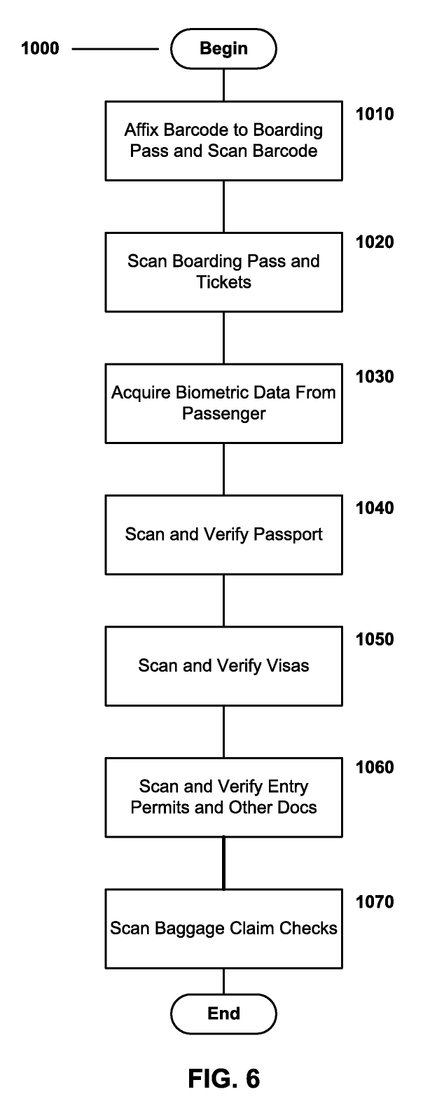

FIG. 6. shows a flowchart 1000 of one embodiment of the workflow associated with check in of a single passenger by a check in agent. The check in agent first affixes a barcode to the to the passenger's boarding pass and reads the barcode 1010 using a barcode reader, for example, 520 of FIG. 5. The agent next scans the passenger's boarding pass and tickets 1020 using a document reader, for example, 510 of FIG. 5. The check in agent then acquires biometric data from the passenger 1030 which may include a acquiring a biometric using a camera, for example, 530 of FIG. 5, or a fingerprint using a fingerprint capture device, for example, 540 of FIG. 5. Biometrics acquired using a camera include, e.g., face scans and iris scans. Finally the agent scans and verifies the passenger's passport 1040, visas 1050, entry permits and other travel documents 1060, and baggage claim checks 1070 using a document reader, for example, 510 of FIG. 5. The acquired data may then be stored on a local storage device, for example, 558 of FIG. 5, and may also be forwarded to and stored on an Airport Server and/or a Central Server. In one embodiment, the data captured by the Check In Recorder locations is consolidated in real-time at an Airport server and then synchronized with a Central Server so that there is a persistent record for the time of the flight. The information may be retained for future analysis.

The barcode of step 1010 may be any manner of printed code capable of encoding a sequence of characters, numbers, or symbols, for example, linear barcodes, 2D barcodes, and stacked barcodes. The barcode reader may be any kind of device capable of recognizing such codes, for example, a conventional laser based linear barcode scanner. The barcode could be printed on the passenger's boarding pass by a printer near the Check In Recorder, could be preprinted on the boarding pass by the issuing airline, or could be on a on a tamper proof (die cut) barcode label that is affixed on the boarding pass at check in time. If the passenger is not carrying a boarding pass, the code could be affixed to any other document required for boarding an airplane, for example, a ticket.

In one embodiment of the scanning step 1020 of FIG. 6, the agent places boarding pass in the document reader, for example, 510 of FIG. 5. The reader captures image of boarding card, and using optical character recognition (OCR) may additionally capture the boarding pass barcode number, the boarding sequence number, the flight number, the flight date, and the destination. If any information is not captured, the agent may enter in such information, for example, using the operator interface of the Check In Recorder, for example, the user interface implemented on the touch sensitive display 558 of computer 550 in FIG. 5. Additionally, the agent may also place the passenger's ticket in the document reader. The reader may then capture the image of the ticket and may extract information from the ticket, for example, the ticket number.

In one embodiment of the biometric data acquisition step 1030 of FIG. 5, the agent first asks a passenger checking in to look at the biometric camera of the Check In Recorder, for example, 530 of FIG. 5 (with lighting 534). Both the camera and the lighting associated with the camera may be intelligent or self adjusting to insure the best possible image is acquired. For example, the lighting 534 of FIG. 5 may automatically adjust the intensity of the lighting based on ambient conditions to ensures that there is proper biometric lighting (e.g., face lighting) that will allow for optimal biometric recognition. The camera may also automatically take many photos over a short period of time. Software within the camera or within a computer in the Check In Recorder system may then select and store the most suitable image for biometric recognition without operator intervention.

If passenger refuses to submit to the recording of camera based biometric, then the agent may ask the passenger to put his or her index finger of their right hand on to a fingerprint capture device, for example, 540 of FIG. 4. The fingerprint capture device then captures the fingerprint. The agent the agent may then mark the passenger's boarding pass to indicate that a fingerprint was used and if not the right index finger, which finger.

In one embodiment of the passport scanning and verification step 1040 of FIG. 6, the agent first places the passenger's passport with data page open in document reader, for example, 510 of FIG. 5. The document reader then captures a document image, a passenger photo image, and MRZ data (if available) from the passport. Images may be captured using a variety of light sources in addition to visible light, for example ultraviolet A and B and near infrared. The captured images may then be analyzed and verified by the Check In Recorder, for example, by software resident on the computer 550 of FIG. 5.

For example, the Check In Recorder may verify conformance to document security features and absence of alterations or fraud using visible, ultraviolet A and B, and near infrared images using an extensive library of validity checks that may include most countries and most passport types. The Check In Recorder may additionally determine whether the MRZ and printed data are consistent. The Check In Recorder may optionally compare the captured image of the passenger with image of passport photo and advise the check in agent if there is match. Where the passport photo is not suitable for face recognition, the agent may be prompted to check the face image manually to determine if this is the rightful holder of the passport. The Check In Recorder may also perform a No Fly List and Selectee List for check United States bound passengers based on the acquired passport information.

In one embodiment of the visa scanning and verification step 1050 of FIG. 6, the agent first places the passenger's passport with visa page open in the document reader, for example, 510 of FIG. 5. The document reader then captures a visa page image and MRZ data (if available) from the passport. The captured images may then be analyzed and verified by the Check In Recorder, for example, by software resident on the computer 550 of FIG. 5.

For example, the Check In Recorder may compare machine readable visas with visa requirements for the destination country and determines if the visa is suitable. Otherwise the Check In Recorder prompts the Agent to check the visa against visa requirements for destination country and nationality of traveler. For non-machine readable visas, the agent can check a visa help file hosted on the Check In Recorder to determine what the visa requirements are for the destination for a person of the passenger's nationality.

Where transit and stop-over visas are present on the passenger's passport, the Check In Recorder may compare machine readable visas with visa requirements for the transit or stop-over country and determines if the visa is suitable. Otherwise, the Check In Recorder may prompt the Agent to check the visa against visa requirements for destination country and nationality of traveler. For non-machine readable visas, the agent may check a visa using a visa help file hosted on the Check In Recorder to determine what the visa requirements are for the destination for a person of the passenger's nationality.

In the remaining steps of the workflow, entry permit, travel documents, and baggage claim check scanning steps 1060 and 1070 of FIG. 6, images of the passenger's ECNR stamps (passport), additional travel documents or ID's, and baggage claim checks are scanned into the Check In Recorder using a document reader, for example, for example, 510 of FIG. 5. The captured images may then be analyzed and verified by the Check In Recorder, for example, by software resident on the computer 550 of FIG. 5.

All of the information captured during passenger check in may then be recorded in a Passenger Information Record. The Passenger Information Record may be stored on a local storage device of the Check In Recorder, for example, 558 of FIG. 5, and may also be forwared to and stored on an Airport Server and/or a Central Server. For example, the captured by the Check In locations may be consolidated in real-time at an Airport server and then synchronized with a Central Server so that there is a persistent record for the time of the flight. The information may be retained for future analysis. The Passenger Information Record may be keyed to, inter alia, the passenger's boarding pass barcode number. The Record may also be keyed to passenger demographic information such as name or passport number.

The Passenger Information Record may thus include the following data:

Picture of Passport ID page

Picture of Visa Page

Picture of Boarding Pass

Picture of relevant ticket foil/coupon

Picture of the ECNR (Emigration Clearance Not Required stamp) page.

Photograph of the passenger.

Fingerprint Data of the passenger, if necessary.

Name of the passenger (as in the passport)

Passenger's Date of birth (as in the passport)

Nationality of the passenger (as in the passport)

Passenger Passport number (as in the passport)

Passenger Passport date of issue (as in the passport)

Passenger Passport date of Expiry (as in the passport)

Flight number and date (as on the boarding pass)

Boarding Sequence number (as on the boarding pass)

Luggage tag numbers, if applicable

Ticket Type (TAT, OPTAT, ET etc.)

Ticket number

Destination (as on the boarding pass)

At any time during the check in process, an event occurs that raises a security concern, for example, a passport appears to be fraudulent or a passenger appears on a No Fly list, the Passenger Information Record for the passenger may be forwarded automatically to a security monitoring station. The Passenger Information Record may be made available to any authorized person who has access to the system. A computer monitor and key board can be provided for airline security to monitor for alerts and to analyze identified anomalies. A color printer may be additionally provided for each airport so that the face images can be printed out, viewed, and circulated as required.

The system may be configured so that the operators themselves are not aware of any ‘flag’ on the passenger thus avoiding alerting the passenger of any suspicion and/or avoiding any commotion among the passengers at this point, this flag/information should be available at a security/supervisor monitoring station. For example, there would be no audible signal that would alert the passenger. The screens on the Check In Recorder displays may additionally have a privacy coating so that the passenger will not be able to read the screen from his normal position in the flow of passengers.

The operator may be made aware of routine issues where a visual inspection can usually resolve any doubt. For example, the PAX record may just have first and last name and when the passport is read, there may be other names as well. The operator may be permitted to accept this depending on the airline policy. If there is a serious discrepancy, then the operator will be given the level of information needed to direct the passenger to do what is required by airline procedures. If for instance there is a switch of documents identified, then the operator will be advised to ask the person to step aside and speak with security.

The Check In Recorder system may be configured such that a supervisor must open the flight on the system when the staff and equipment are ready to start processing passengers. This sets up all of the data required for the flight including PAX, NFL and SL data. The supervisor enters a flight number and gate number. A supervisor may then close a flight when the passengers are on board. On closing, the composite Passenger Information Record may be prepared for the flight and readied to transmit to the local Airport Server, the Central Server where it becomes available to the destination Airport Server. A printed manifest for the flight plus a back-up electronic media such as a CD or memory stick may prepared and provided to the flight crew before departure.

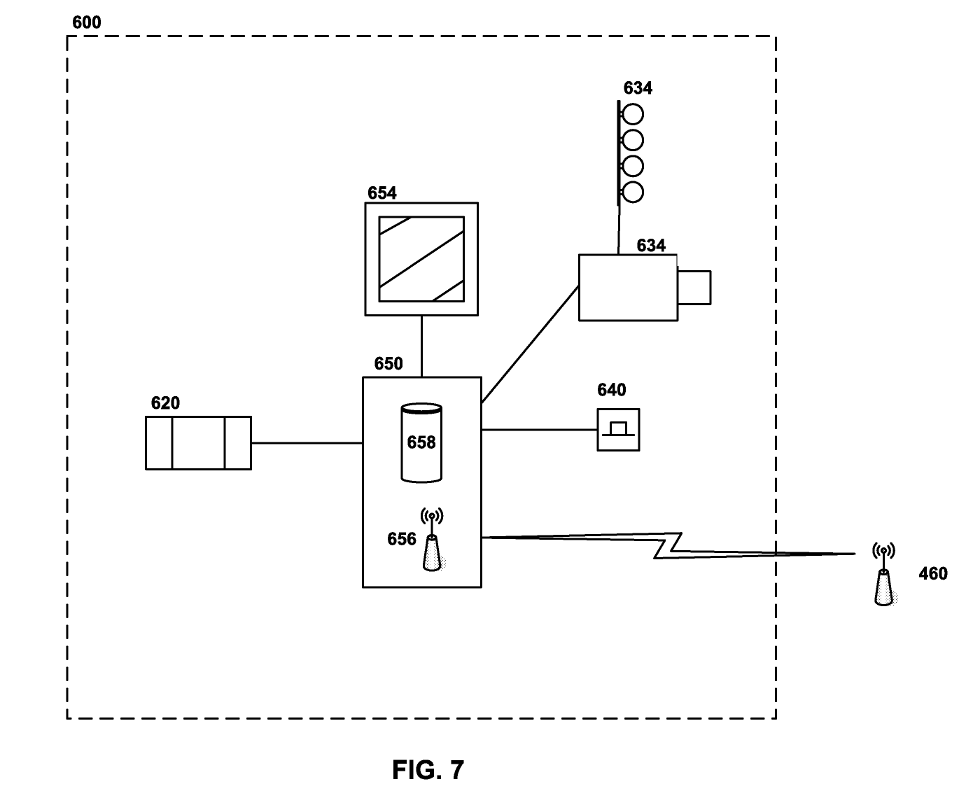

FIG. 7 is a conceptual illustration of one embodiment a Verifier system 600. The Verifier is a device located at or near the departure gate for use in permitting passengers into the holding area for a flight or at the point of actually boarding a flight. The device may implemented as a mobile device that may be freely moved between gates. One purpose of the device is to ensure that there has been no swapping of boarding passes after check in. The device may also be used to check passengers as they are deplaning. In such case, the purpose is to ensure that the people that were supposed to deplane did and that the passengers that were destined for a subsequent stop did not deplane. This allows checking for swapped boarding passes and for stowaways.

The embodiment shown in FIG. 7 includes: a bar code reader 620; a biometric camera 630 with lighting 634; and a fingerprint capture device 640. All components may be connected to a computer 650 with touch sensitive monitor 654 for an operator interface and a local storage device 658, for example a hard drive. The device may be connected to a wireless network though a wireless connection device 656, such as an 802.11g compatible device.

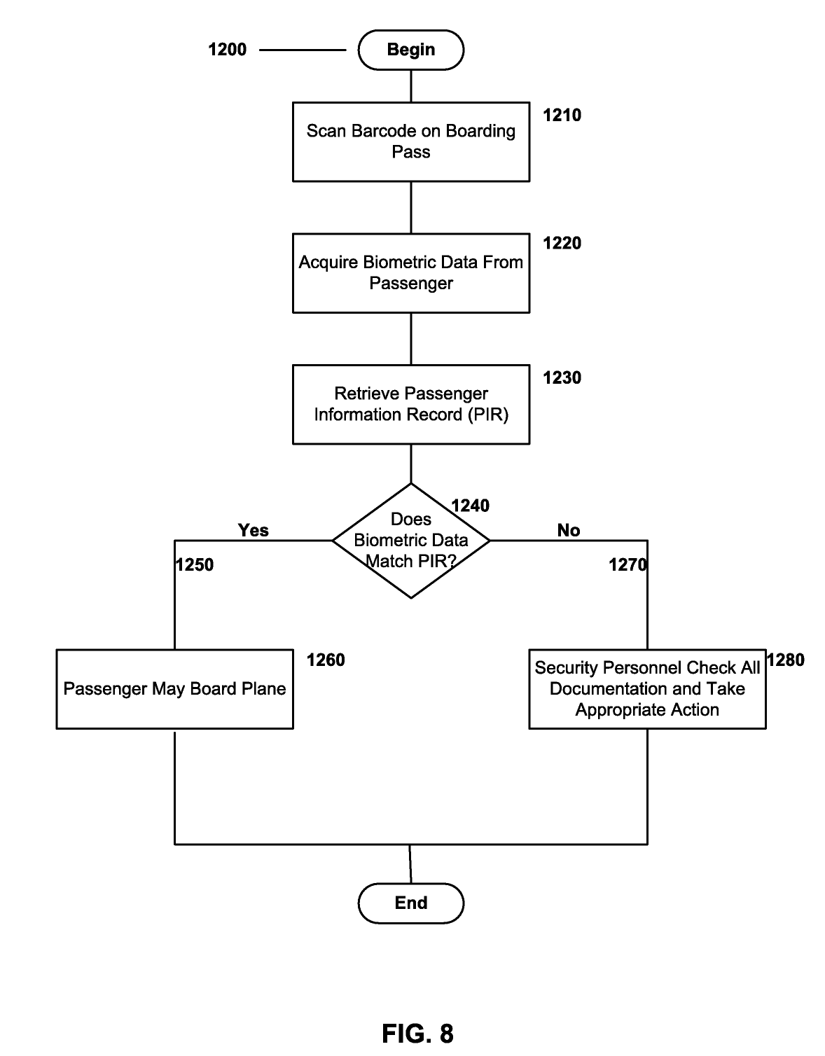

FIG. 8 shows a flowchart 1200 of one embodiment of the workflow associated with the verification of a single passenger boarding an airplane by a airline agent. The scans the barcode on the passenger's boarding pass 1210 using a barcode reader, for example, 620 of FIG. 7. T he agent then acquires biometric data from the passenger 1220 which may include a acquiring a biometric using a camera, for example, 630 of FIG. 7, or a fingerprint using a fingerprint capture device, for example, 640 of FIG. 7. The acquired data may then be stored on a local storage device, for example, 658 of FIG. 7, and may also be stored on an Airport Server and/or a Central Server. For example, the data captured by the Verifier locations may be consolidated in real-time at an Airport server and then synchronized with a Central Server so that there is a persistent record for the time of the flight. The information may be retained for future analysis.

All, or a portion of, the Passenger Information Record corresponding to barcode on the passenger's boarding pass is then retrieved 1230 from a Check In Recorder, an Airport Server, or a Central Server. The data acquired by the Verifier system is compared 1240 to the data in the Passenger Information Record retrieved in step 1230 above. If the Verifier system confirms that this is the same person that checked in 1250, the passenger will be allowed to board 1260. For example, facial or fingerprint biometrics may be compared using advanced face or fingerprint recognition algorithms. If there is not a match 1270, the agent or Security personnel will check all documentation 1280 to determine if there has been a switch of boarding passes. The Verifier system may produce an audible beep on positive verification/confirmation and an appropriate audible sound/alarm as well as an alert (flag) on the screen, if the verification is negative. For example, the Verifier system may produce an audible beep when the bar code is read and then a second audible beep when a match is confirmed. Failure to match (a no-match) may be displayed on the screen of the Verifier system with appropriate operator instructions.

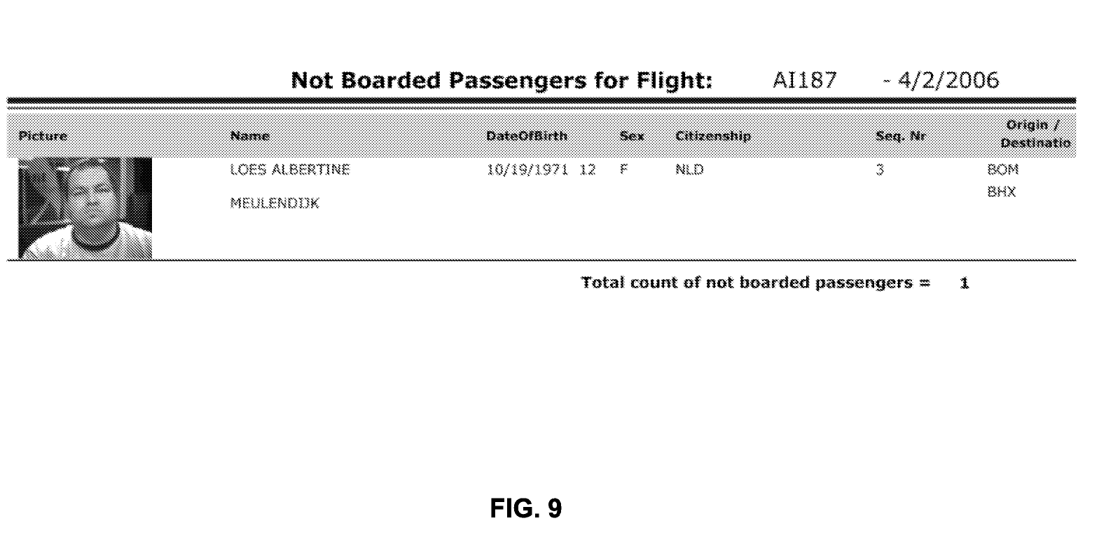

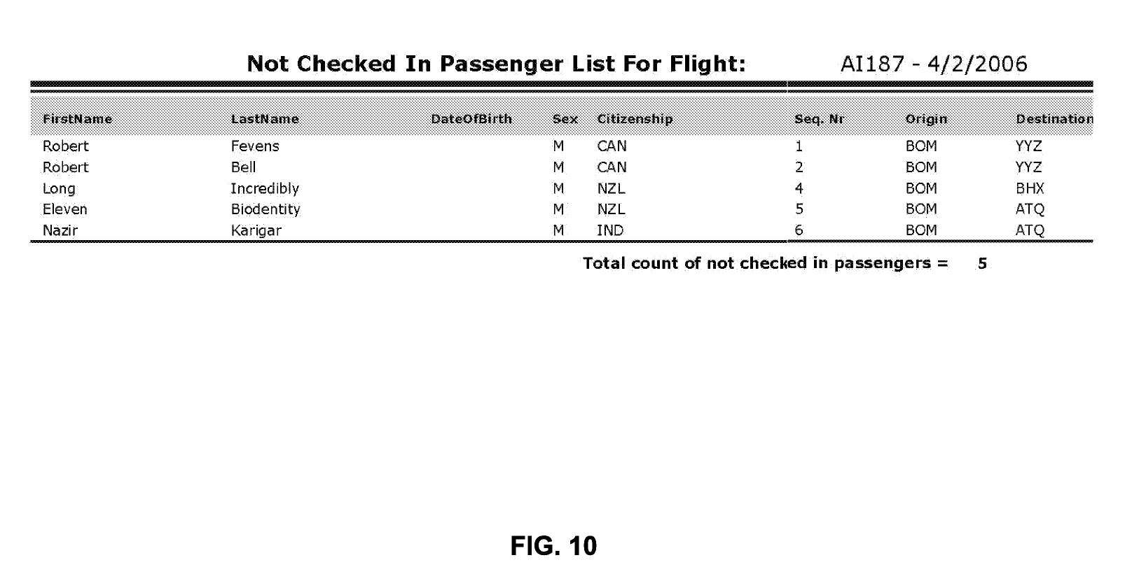

The system may be implemented such that, at any time, the operator at the Verifier system may produce a report of the passengers that have checked-in but not reported to the gate. One embodiment of such a report is shown in FIG. 9. The system may additionally provide a report of scheduled passengers who have not checked in. FIG. 10 shows one embodiment of such a report. On completion of the boarding process, the Airport Server may then confirm to the Verifier system that all the passengers for a given flight have boarded the aircraft. A ‘Passenger Information Record’ File for the flight may then be automatically created by, for example, an Airport Server. The Passenger Information Record file for the flight may be immediately transmitted via secure communications to the enroute (intermediate) stations and destination airport and also be stored in a Central Server database. The Airport Server may then to confirm to the Verifier that all the passengers for a given flight have boarded the aircraft.

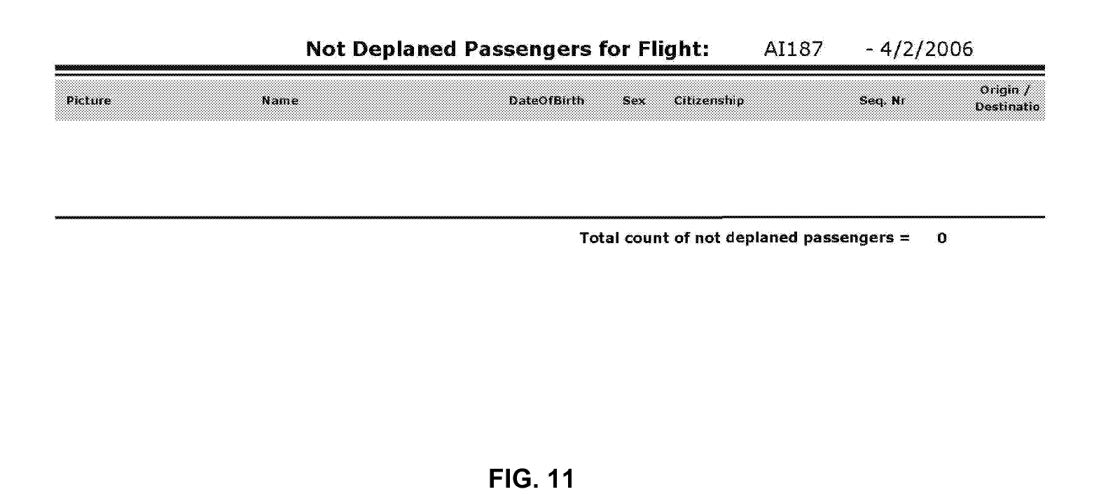

The all or a portion of the workflow 1200 associated with verifying boarding passengers may also be applied to passengers deplaning at a gate. At a minimum, the barcode on a deplaning passenger's boarding pass may be scanned, as in step 1210. Additional steps in the workflow may be executed for enhanced security. If deplaning passenger's boarding passes are scanned for all passengers exiting the aircraft, the Verifier may additionally retrieve passenger manifest data from the Airport or Central Server for the flight being deplaned and produce a report to confirm that the correct passengers have deplaned and that there are no passengers remaining on the plane that should have deplaned. FIG. 11 shows one embodiment of such a report. Such a report may, inter alai, help prevent passengers from sleeping through their disembarkation stops at intermediate transit stations.

The functions of a Check In Recorder system and a Verifier system may additionally be combined in a single mobile unit, referred to hereinafter as a Combo Recorder/Verifier. The Combo Recorder/Verifier is a device located at or near the departure gate for use in capturing the Passenger Information Record doing NFL and SL checks, authenticating travel documents, validating conformance to visa requirements and confirming that the passenger is the rightful holder of the travel documents. The device may implemented as a mobile device that may be freely moved between gates. The device may be used for all passengers that have not gone through the check in process described in above. Hence, it may be used for all airline flights from international airports and at the transfer desks in-country for connecting passengers in-country from other airlines.

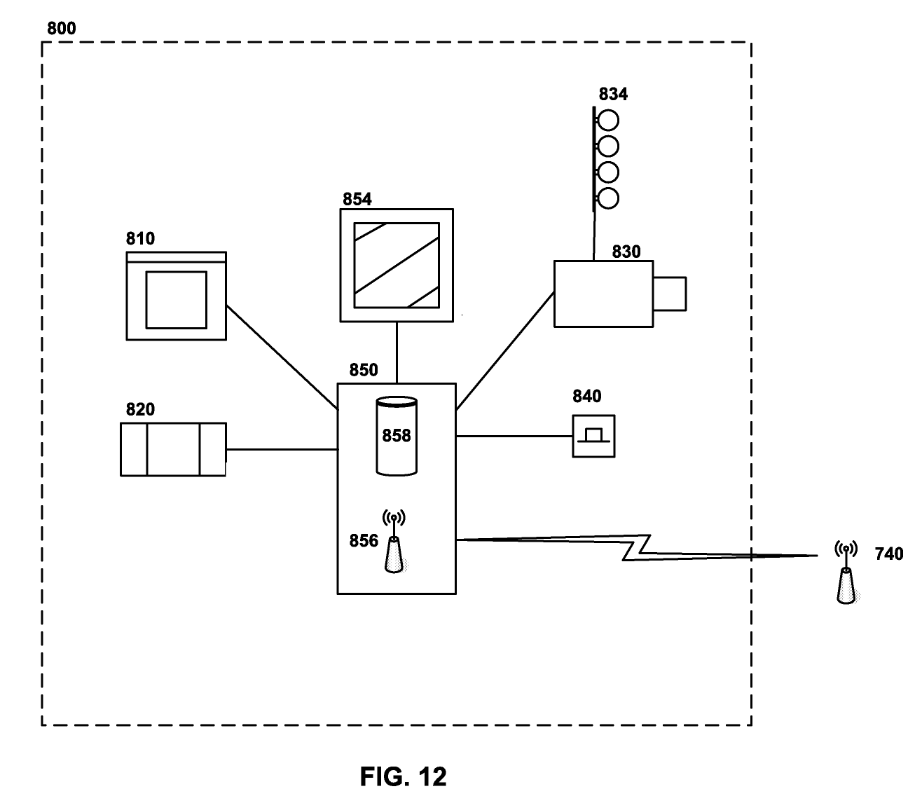

FIG. 12 illustrates one embodiment of a Combo Recorder/Verifier system 800. The embodiment includes: a full page A3 travel document reader and authenticator 810; a bar code reader 820; a biometric camera 830 with lighting 834; and a fingerprint capture device 840. All components may be connected to a computer 850 with touch sensitive monitor 854 for an operator interface and a local storage device 858, for example a hard drive. The device may be connected to a wireless network though a wireless connection device 856, such as an 802.11g compatible device.

Deplaning passengers without a Passenger Identification Record (i.e. those who have not previously checked in at a Check In Recorder) are checked in and verified using a check in process substantially identical to that described in FIG. 6 above. The resulting Passenger Information Record may recorded and stored in real time on an Airport Server and to a Central Server in real time or when the Combo Recorder/Verifier is returned to its storage area. Additionally, the Combo Recorder/Verifier may retrieve passenger manifest data from the Airport or Central Server for the flight being deplaned and produce a report to confirm that the correct passengers have deplaned and that there are no passengers remaining on the plane that should have deplaned. FIG. 11 shows one embodiment of such a report.

Combo Recorder/Verifier can be configured to operate as a peer network at the gate lounge and have no connectivity to the Network or central server while the boarding or deplaning is taking place. These devices may communicate with each other in order to compile a complete passenger transaction data set for redundancy purposes in addition to ease uploading to a Central server. Once the Combo units are moved to a storage area, they may communicate wirelessly to a secure IPSEC VPN connection.

It will be readily apparent to those skilled in the art that the system as described above may be used to enhance the ability of transportation authorities to solve specific transportation security issues. For example, passengers may travel on fraudulent entry documents to international destinations with the intention of seeking illegal entry/migration/political asylum. In one embodiment of the system, each passenger's travel document is checked to confirm that it is an authentic document. The photo on the passport is compared to the photo of the passenger to confirm that the person is the rightful holder of the passport. The passenger's visa is checked to confirm that the visa is authentic and valid for the period required. Copies of the passenger's passport, visa, ticket, boarding pass and baggage bar codes and other stamps are captured so that there is a clear record of the people on the flight if someone does claim illegal entry/migration/political asylum.

Another transportation security issue that embodiments of the system may help to resolve is the case where passengers swap boarding passes in the security hold of the airport or on board the aircraft and travel on unauthorized sectors of the flight to onward international destinations for the purpose of seeking illegal migration by circumventing immigration control in the country of origin. In one embodiment of the system, during the course of check in, a unique barcode affixed to the passenger's boarding pass or printed directly onto the boarding pass. To avoid swapping of boarding passes in the security hold, each passenger boarding pass barcode is read and a photo taken of the passenger's face. The face image is compared automatically to the face on record when the passenger checked in. If it is the same person, the passenger is allowed to board. To avoid swapping on the plane, the face biometric is checked for all passengers that are proceeding onward from an intermediate stop. If the passenger destroys his documentation prior to reaching the immigration point in a foreign country, security personnel will have the opportunity to check their records for anyone that arrived and with the face image will be able to link that person to his passport and visa because these items were captured at check-in.

Another transportation security issue that embodiments of the system may help to resolve is the case where passengers inadvertently board the wrong flight. In one embodiment of the system, the barcode on the boarding card that was applied or printed on it at check-in will be read at the gate. If that barcode does not belong to a person on the flight that is departing from that gate, the anomaly will be flagged and the attendant will direct the person to the correct gate.

Another transportation security issue that embodiments of the system may help to resolve is the case of inadmissible passengers who travel as domestic passengers and swap their boarding passes with international passengers who act as agents/facilitators. The opportunity for this is when an airline is flying the first leg of an international flight in-country. Domestic passengers do not need either a visa or a passport. A domestic passenger could swap boarding passes with a legitimate international passenger and attempt to stay on the plane undetected. In one embodiment, the system may provide the capability to check each passenger that disembarks by reading the barcode, capturing the face image and comparing the face image with the record on file for the holder of the boarding pass. If they match, the person is permitted to deplane. If not, he is held for further questions. At the end of the domestic passenger deplaning process an exception report will be generated to identify if there were any passengers that should have deplaned that did not.

Another transportation security issue that embodiments of the system may help to resolve is the case where of missing departure passengers and their registered baggage. In one embodiment, the operator at the Verifier may print a report of the passengers that have checked-in but not reported to the gate. To make this easier for the agent, the list will include a photo of all passengers that were checked in using the smart biometric camera.

While the invention has been particularly shown and described with reference to embodiments thereof, it will be understood by those skilled in the art that various changes in form and details may be made therein without departing from the spirit and scope of the invention.

We claim:

1. A system for passenger identity verification, comprising:
at least one check in system comprising a first bar code reader and a first biometric data collection device, configured such that when a passenger checks in, a barcode is placed on the passenger's boarding documents, a first set of bar code data is collected from the barcode by the first barcode reader and a first set of biometric data is collected from the passenger by the first biometric data collection device;
a server operatively connected to the at least one check in system, the server having a database for storing passenger data, the server being configured to receive the first set of barcode data and the first set of biometric data and store the first set of barcode data and the first set of biometric data in the database such that the first set of bar code data is associated with the first set of biometric data;
at least one verification system operatively connected to the server comprising a second bar code reader and a second biometric data collection device, configured such that when the passenger arrives at the at least one verification system, a second set of bar code data is collected from the barcode by the second barcode reader and a second set of biometric data is collected from the passenger by the second biometric data collection device, the first set of biometric data is retrieved from the database using the second set of bar code data, and the first set of biometric data is compared with the second set of biometric data.

2. The system of claim 1 wherein if first set of biometric data matches the second set of biometric data, the passenger is allowed to proceed, and if not, additional security checks are performed.

3. The system of claim 2 wherein the additional security checks are selected from the group: manual verification of the passenger's travel documents, interrogation of the passenger by security personnel.

4. The system of claim 1 wherein the at least one check in system additionally comprises a document reader and verifier wherein when a passenger checks in, passenger data is collected from the passenger's travel documents and the travel documents are verified using the document reader and verifier.

5. The system of claim 4 wherein the passenger's travel documents are selected from the group: passports, visas, tickets, baggage claim checks.

6. The system of claim 4 wherein the passenger data stored on the server in association with first set of bar code data and the first set of biometric data

7. The system of claim 3 wherein at least one check in system additionally comprises security data stored on the at least one check in system wherein the passenger data is compared to the security data.

8. The system of claim 7 wherein the security data is selected from the group: United States Transportation Security Administration No Fly List, Selectee List.

9. The system of claim 1 wherein the server and/or the at least one verifier system is capable of producing a report regarding the passengers scheduled to board at least one transportation vehicle, the report being selected from the group: passengers not checked in, passengers checked in, but not boarded.

10. A system for verifying passengers have exited a transportation vehicle, comprising:
a server having a database storing passenger data, wherein the data comprises a manifest of a plurality of passengers who have boarded the transportation vehicle;
at least one verification system operatively connected to the server comprising a means for collecting identifying data from a passenger, wherein
when at least one of the plurality of passengers exits the vehicle, the passenger is identified and the manifest is updated to note the at least one passenger has exited the transportation vehicle.

11. The system of claim 10 wherein the server and/or the at least one verifier system is capable of producing a report showing all passengers scheduled to exit the transportation vehicle.

12. A method for passenger identity verification, comprising the steps:
placing a barcode on a passenger's boarding documents upon check in;
reading a first set of bar code data from the bar code with a first bar code reader;
collecting a first set of biometric data from the passenger with a first biometric collection device;
storing the first set of barcode data and the first set of biometric data on a server such that the first set of bar code data is associated with the first set of biometric data;
reading a second set of bar code data from the bar code with a second bar code reader;
retrieving the first set of biometric data from the server using the second set of bar code data; and
comparing the first set of biometric data with the second set of biometric data.

13. The system of claim 12 wherein if first set of biometric data matches the second set of biometric data, the passenger is allowed to proceed, and if not, additional security checks are performed.

14. The system of claim 13 wherein the additional security checks are selected from the group: manual verification of the passenger's travel documents, interrogation of the passenger by security personnel.

15. The system of claim 12 comprising the additional step of collecting passenger data from a passenger's travel documents and verifying the travel documents.

16. The system of claim 15 wherein the passenger's travel documents are selected from the group: passports, visas, tickets, baggage claim checks.

17. The system of claim 15 comprising the additional step of comparing the passenger data to security data.

18. The system of claim 17 wherein the security data is selected from the group: United States Transportation Security Administration No Fly List, Selectee List.
